(19) United States
(12) Patent Application Publication
(10) Pub. No.: US 2005/0047284 A1
(43) Pub. Date: Mar. 3, 2005

(54) Heat exchanger using magnetic heat storage material included in cooling water

(76) Inventor: Masashi Takagi, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/931,007

(22) Filed: Aug. 31, 2004

(30) Foreign Application Priority Data
Sep. 2, 2003 (JP) 2003-310228

(51) Int. Cl. G11B 11/00

(52) U.S. Cl. 369/13.14

(57) ABSTRACT

In a cooling water channel 11 through which cooling water circulates, a heater core 15 in which the cooling water heats air supplied from a blower 16, a heat absorbing part 13 in which the cooling water absorbs heat from a vehicle engine 12, which is an object from which heat is absorbed, and an electric water pump 14 for circulating the cooling water are arranged. A magnetic heat storage material that is, when magnetized, put into a high-temperature state because of a rise in temperature and which is, when demagnetized, put into a low-temperature state because of a fall in temperature due to a magneto-caloric effect, is mixed into the cooling water. A permanent magnet 17 for applying a magnetic field to the fluid is arranged on the heater core 15.

### BACKGROUND OF THE INVENTION

1. Field of the Invention

The present invention relates to a heat exchanger using a magnetic heat storage material that is, when magnetized, put into a high-temperature state because of a rise in temperature and which is, when demagnetized, put into a low-temperature state because of a fall in temperature due to a magneto-caloric effect.

2. Description of the Related Art

Conventionally, a heat exchanger (a refrigerating device) using a magnetic heat storage material, which has been disclosed in Patent document 1, is widely known. The refrigerating device, as shown in FIG. 7, comprises a circulation channel 11 through which a heat exchanger fluid circulates, and in the circulation channel 11, a heat absorbing device (a cooling device) 51 in which the heat exchanger fluid absorbs heat from an object with which heat exchange is effected, a heat radiating device 52 in which the heat exchanger fluid radiates heat to the object with which heat exchange is effected, a circulating means 14 for circulating the heat exchanger fluid through a heat exchanger channel, and two magnetic heat storage containers 54a and 54b in which magnetic heat storage materials 53a and 53b are accommodated, respectively, and which effect heat exchange with the heat exchanger fluid, are arranged. Moreover, the heat exchanger described in Patent document 1 comprises a magnetic field generation means 17 for applying a magnetic field to the magnetic heat storage materials.

In the heat exchanger, the magnetic heat storage containers 54a and 54b are moved between a place with a magnetic field (a magnetized place) and a place without a magnetic field (a demagnetized place) by a drive means 57. Due to this, the magnetic heat storage materials 53a and 53b can be put into two states, namely a magnetized high-temperature state and a demagnetized low-temperature state. Moreover, they are moved in such a manner that when one of the magnetic heat storage containers is in a high-temperature state, the other is in a low-temperature state. Here, a state in which the magnetic heat storage container 54a is in a magnetized high-temperature state and the magnetic heat storage container 54b is in a demagnetized low-temperature state is referred to as a first state, and a state in which the magnetic heat storage container 54a is in a demagnetized low-temperature state and the magnetic heat storage container 54b is in a magnetized high-temperature state is referred to as a second state.

By the way, the circulation channel 11 comprises a channel switching means 55. In the case of the first state (indicated by the arrow a in FIG. 7), the channel switching means 55 controls the channel of the heat exchanger fluid so as to make the fluid flow in a route from the circulating means 14, to the magnetic heat storage container 54b (heat radiation), to the cooling device 51 (heat absorption), to the magnetic heat storage container 54a (heat absorption), to the heat radiating device 52 (heat radiation) and to the circulating means 14. The terms in the above parenthesis indicate the state of heat transfer when viewed from the heat exchanger fluid side.

On the other hand, in the case of the second state (indicated by the arrow b in FIG. 7), the channel switching means 55 controls the channel of the heat exchanger fluid so as to make the fluid flow in a route from the circulating means 14, to the magnetic heat storage container 54a (heat radiation), to the cooling device 51 (heat absorption), to the magnetic heat storage container 54b (heat absorption), to the heat radiating device 52 (heat radiation) and to the circulating device 14.

As described above, it is possible to effect heat exchange (for the fluid to absorb heat from an object to be cooled 56) in the cooling device 51 by alternately creating the two states, namely the first and second states by moving the magnetic heat storage containers 54a and 54b by means of the drive means and by switching the channels of the heat exchanger fluid by means of the channel switching means 55.

[Patent Document 1]
Japanese Unexamined Patent Publication (Kokai) No. 2002-106999

In the heat exchanger (the refrigerating device) disclosed in Patent document 1, however, it is necessary to provide the drive means 57 in order to move the magnetic heat storage containers 54a and 54b between a place with a magnetic field (a magnetized place) and a place without a magnetic field (a demagnetized field) because the magnetic heat storage materials 53a and 53b are accommodated in the magnetic heat storage containers 54a and 54b, respectively.

Moreover, the cooling of the object to be cooled 56 in the cooling device 51 is performed continuously in such a manner that the two magnetic heat storage containers 54a and 54b are moved alternately between the magnetized place and the demagnetized place and, in accordance with this, the channel switching means 55 switches and controls a channel a of the heat exchanger fluid in the first state and a channel b in the second state. Therefore, the circulation channel 11 of the heat exchanger fluid has to be provided with the channel switching means 55.

### SUMMARY OF THE INVENTION

The present invention has been developed with the above-mentioned problem being taken into account, and the object thereof is to provide a heat exchanger using a magnetic heat storage material, which has a more simple structure.

In order to achieve the above-mentioned object, a heat exchanger according to a first aspect of the present invention comprises a circulation channel (11) through which a fluid circulates and in the circulation channel (11), a heating type heat exchanging means (15) in which the fluid heats an object to be heated, a heat-absorbing type heat exchanging means (13) in which the fluid absorbs heat from an object to be cooled, and a circulating means (14) for circulating the fluid are arranged. The heat exchanger is characterized in that: a magnetic heat storage material that is, when magnetized, put into a high-temperature state because of a rise in temperature and which is, when demagnetized, put into a low-temperature state because of a fall in temperature due to a magneto-caloric effect thereof, is mixed into the fluid; and that a magnetic field generation means (17) for applying a magnetic field to the fluid is arranged on the heating type heat exchanging means (15).

According to the first aspect, as the magnetic heat storage material is mixed into the fluid in the circulation channel (11) and the fluid and the magnetic heat storage material are circulated together in the circulation channel (11) by the circulating means (14), the containers for accommodating the magnetic heat storage material and the drive means for moving the containers described in Patent document 1 can be dispensed with.

Moreover, as the magnetic field generation means (17) is arranged in the heating type heat exchanging means (15) and a magnetic field is applied to the fluid, the magnetic heat storage material that has been magnetized and put into a high-temperature state and the high temperature fluid that has been heated by the magnetic heat storage material and the temperature of which has been raised radiate heat to the object to be heated in the heating type heat exchanging means (15). Then, after passing through the heating type heat exchanging means (15), the magnetic heat storage material is demagnetized and put into a low-temperature state and the fluid therearound is also put into a low-temperature state, enabling heat absorption in the heat-absorbing type heat exchanging means (13).

As described above, heat absorption by the heat-absorbing type heat exchanging means (13) and heating by the heating type heat exchanging means (15) can be performed continuously and, therefore, it is no longer necessary to move the two magnetic heat storage containers alternately between the magnetized place and the demagnetized place and in accordance with this, for the channel switching means to switch and control the channels, which is necessary in the heat exchanger disclosed in Patent document 1. Therefore, it is possible to dispense with the channel switching means, which is indispensable to the heat exchanger disclosed in Patent document 1.

Due to the effects described above, it is possible to simplify the structure of a heat exchanger using a magnetic heat storage material compared to that in Patent document 1.

Moreover, as the magnetic heat storage material is mixed into the fluid in the circulation channel (1), it is possible to improve the heat-exchanging efficiency because the contact area between the magnetic heat storage material and the fluid is increased compared to the case where heat exchange is effected between the magnetic heat storage material in the container and the fluid as described in Patent document 1.

A heat exchanger according to a second aspect of the present invention is characterized in that the magnetic field generation means (17) is arranged integrally with the heating type heat exchanging means (15) so as to apply a magnetic field to at least a part of a fluid channel in the heating type heat exchanging means (15), in the first aspect.

According to the second aspect, as the magnetic field generation means (17) is enabled to apply a magnetic field to a part of the fluid channel in the heating type heat exchanging means (15), it is possible to apply a magnetic field to the fluid in a part of the fluid channel, the temperature of which is to be raised, so that the magnetic heat storage material in the fluid at the part is magnetized and put into a high-temperature state and as a result, the temperature of the fluid can be raised.

As in a third aspect of the present invention, if a part (15e) in the heating type heat exchanging means (15), which includes a fluid channel to which a magnetic field is applied, is formed of a non-magnetic material, in the second aspect, the magnetic field is transferred more effectively from the magnetic field generation means (17) to the magnetic heat storage material in the fluid so that the magnetic heat storage material can be magnetized and put into a high-temperature state.

As in a fourth aspect of the present invention, if the heating type heat exchanging means (15) is provided with a magnetic field shielding plate (18) for blocking the magnetic field from the magnetic field generation means (17) in the third aspect, the magnetic heat storage material can be magnetized only at a required part of the fluid channel and it is possible to more certainly adjust the temperature of the fluid in the fluid channel.

A heat exchanger according to a fifth aspect of the present invention comprises: a plurality of circulation channels (20, 21, 24) through which a fluid circulates; circulating means (14a, 14b, 14c) arranged in the plurality of circulation channels (20, 21, 24), respectively, and circulating the fluid; intermediate heat exchanging means (23a, 23b) arranged in the plurality of circulation channels (20, 21, 24), respectively, for effecting heat exchange with the cooling water in the other circulation channels (20, 21, 24); a heating type heat exchanging means (15) arranged in a first circulation channel (20), which is one of the plurality of circulation channels (20, 21, 24) and in which the fluid heats an object to be heated; and a heat-absorbing type heat exchanging means (13) arranged in a second circulation channel (21), which is one of the plurality of circulation channels (20, 21, 24) except for the first circulation channel (20) and in which the fluid absorbs heat from an object to be cooled; and the heat exchanger is characterized in that: a magnetic heat storage material that is, when magnetized, put into a high-temperature state because of a rise in temperature and which is, when demagnetized, put into a low-temperature state because of a fall in temperature due to a magneto-caloric effect, is mixed into the fluid; a magnetic field generation means (17a) for applying a magnetic field to the fluid in the first circulation channel is arranged on the heating type heat exchanging means (15); and the respective intermediate heat exchanging means (23a, 23b) comprise respective magnetic field generation means (17b, 17c) for applying a magnetic field to the fluid in the circulation channels (21, 24) for heating and respective magnetic field shielding plates (18a, 18b) for enabling the magnetic field generation means (17b, 17c) of the intermediate heat exchanging means (23a, 23b) to apply a magnetic field to only the fluid in the circulation channels (21, 24) for heating.

According to the fifth aspect, the fluid in the second circulation channel (21) absorbs heat from an object to be cooled in the heat-absorbing type heat exchanging means (13). Then, the fluid in the plurality of circulation channels (20, 21, 24) transfers heat to the fluid in the first circulation channel (20) via the intermediate heat exchanging means (23a, 23b) having the magnetic field generation means (17b, 17c). As a result, the fluid in the first circulation channel (20) heats an object to be heated in the heating type heat exchanging means (15) having the magnetic field generation means (17a).

Due to this, the temperature of the fluid in the heating type heat exchanging means (15) becomes higher than that in the case where there is only one circulation channel and, therefore, it will be possible to apply more heat to an object to be heated.

As in a sixth aspect of the present invention, if magnetic heat storage materials having different Curie temperatures are mixed into the fluid in the circulation channels (20, 21, 24), respectively, in the fifth aspect, it will be possible to more effectively effect heat exchange by the use of the magnetic heat storage materials because the magnetic heat storage material having Curie temperature suitable to the temperature zone of each of the circulation channels (20, 21, 24) can be used. Here, Curie temperature refers to a temperature at which magnetism disappears.

A heat exchanger according to a seventh aspect of the present invention is characterized in that the circulating means (14, 14a, 14b, 14c) are arranged between the upstream side of the heating type heat exchanging means (15, 23a, 23b) and the downstream side of the heat-absorbing type heat exchanging means (13, 23a, 23b) in the circulation channels (11, 20, 21, 24) in the heat exchanger according to any one of the first to sixth aspects.

According to the seventh aspect, the heating type heat exchanging means (15, 23a, 23b) having the magnetic field generation means (17, 17a, 17b, 17c) for putting the magnetic heat storage material into a magnetized high-temperature state, and in which the fluid heats an object to be heated, are arranged at the downstream side of the circulating means (14, 14a, 14b, 14c). As a result, even if the magnetic heat storage material in the fluid is magnetized and put into a high-temperature state by the magnetism of the circulating means (14, 14a, 14b, 14c) and the fluid is heated, the fluid is only heated further by the magnetic heat storage material magnetized and put into a high-temperature state by the magnetic field generation means (17, 17a, 17b, 17c) of the heating type heat exchanging means (15, 23a, 23b) at the downstream side and, therefore the adverse influence on the heat exchanging performance of the heat exchanger can be obviated.

A heat exchanger according to an eighth aspect of the present invention is characterized in that the quantity of heat to be exchanged in the heat exchanging means (13, 15, 23a, 23b) is adjusted by the flow rate control of the fluid by the circulating means (14, 14a, 14b, 14c) in the heat exchanger according to any one of the first to seventh aspects.

As described above, if the flow rate of the fluid is controlled by the circulating means (14, 14a, 14b, 14c), the flow rate of the magnetic heat storage material, circulating through the circulation channels (11, 20, 21, 24) together with the fluid, that passes through the magnetic field of the magnetic field generation means (17, 17a, 17b, 17c) is also controlled. As a result, by the adjustment of the flow rate of the fluid by the circulating means (14, 14a, 14b, 14c), the flow rate of the magnetic heat storage material that is magnetized and put into a high-temperature state and which is demagnetized and put into a low-temperature state can also be adjusted and thus the level of the heat exchanging ability of the heat exchanger can be changed.

The symbols in the parenthesis, after each means, indicate the relationship of correspondence with specific means in embodiments, which will be described later.

The present invention may be more fully understood from the description of the preferred embodiments of the invention set forth below, together with the accompanying drawings.

### BRIEF DESCRIPTION OF THE DRAWINGS

In the drawings:

FIG. 1 is a block diagram showing a heat exchanger according to a first embodiment of the present invention.

FIG. 2 is a general perspective view showing a heater core in the first embodiment.

FIG. 3 is a block diagram showing a heat exchanger according to a second embodiment of the present invention.

FIG. 4 is a general perspective view showing a heater core in the second embodiment.

FIG. 5 is a block diagram showing a heat exchanger according to a third embodiment of the present invention.

FIG. 6 is a block diagram showing a heat exchanger according to a fourth embodiment of the present invention.

FIG. 7 is a block diagram showing a heat exchanger (a refrigerating device) described in Patent document 1.

### DESCRIPTION OF THE PREFERRED EMBODIMENTS

(First Embodiment)

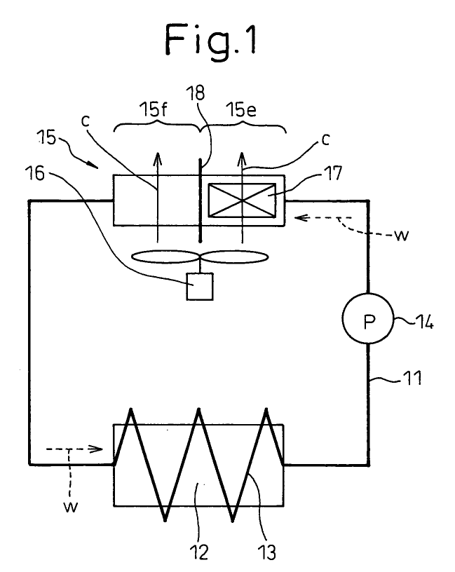

In a first embodiment, the present invention is applied to a heat exchanger in which cooling water, which is a heat exchanger fluid, circulates between a vehicle engine 12, which is a heat producing source, and a heater core 15 for heating air flowing into a car compartment, as shown in FIG. 1.

A cooling water channel 11 through which the cooling water flows is provided with a heat absorbing part 13, which is a heat-absorbing type heat exchanging means and in which the cooling water absorbs heat from the engine 12, an electric water pump 14, which is a circulating means for circulating the cooling water through the cooling water channel 11, and the heater core 15, which is a heating type heat exchanging means and in which the cooling water heats air.

A magnetic heat storage material that exhibits a magneto-caloric effect, in other words, which is, when magnetized, put into a high-temperature state because of a rise in temperature thereof and which is, when demagnetized, put into a low-temperature state because of a fall in temperature thereof, is mixed into the cooling water. In the present embodiment, the magnetic heat storage material is powdery and as a specific material of the magnetic heat storage material, a gadolinium based material may be used.

The cooling water and the magnetic heat storage material mixed into the cooling water circulate through the cooling water channel 11 in the direction of the arrow w in FIG. 1 by means of the electric water pump 14. The electric water pump 14 is arranged at the downstream side of the heat absorbing part 13 and, at the same time, at the upstream side of the heater core 15, in the cooling water channel 11.

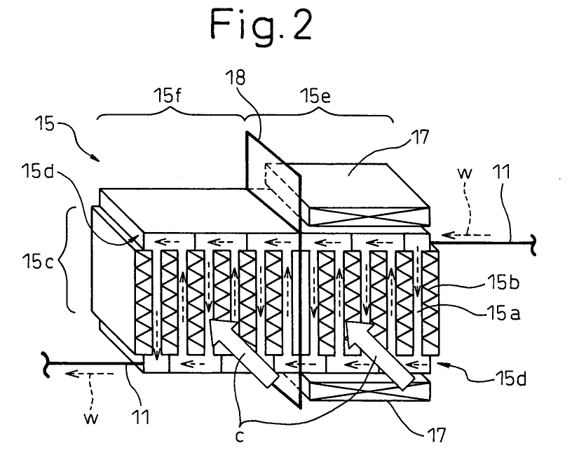

At a part in opposition to the heater core 15, a blower 16 for supplying air to the heater core 15 is arranged. The air supplied from the blower 16 passes through the heater core 15 as shown by the arrow c. To be more specific, as shown in FIG. 2, in the heater core 15, thin metal plates excellent in corrosion resistance such as aluminum are stacked in the horizontal direction in the figure to form tubes 15a through which the cooling water flows and, at the same time, corrugated fins 15b are interposed between the tubes 15a to form a core part 15c that makes up a heating part for heating the air supplied from the blower 16. At both ends of the core part 15c, tank parts 15d for making the cooling water flow into the tubes 15a or into which the cooling water flows from the tubes 15a are arranged.

At parts of the heater core 15 (parts at the side from which the cooling water flows into the heater core 15 in FIG. 2), permanent magnets 17, which are magnetic field generating means, are arranged integrally with the heater core 15 in such a manner as to sandwich the heater core 15 in the vertical direction in FIG. 2, and thereby a magnetic field is applied to the cooling water (the magnetic heat storage material) in the tubes 15a. A part 15e of the heater core 15, to which a magnetic field is applied, is formed of a material that does not block the magnetic field (that does not make the magnetic field into a loop, in other words, that is not magnetized), such as aluminum and copper, so that the magnetic field is applied to the cooling water (the magnetic heat storage material) in the tubes 15a more certainly.

At the boundary between the part 15e to which a magnetic field is applied and a part 15f to which no magnetic field is applied, a magnetic field shielding plate 18 is arranged to prevent a magnetic field from being applied to the cooling water (the magnetic heat storage material) at the part 15f to which no magnetic fields is applied. The magnetic field shielding plate 18 is formed of a magnetic material that blocks the magnetic field (that makes the magnetic field into a loop, in other words, that is magnetized), such as iron and steel.

Next, the operations in the above configuration in the present embodiment are explained below. The cooling water circulates through the cooling water channel 11 in the direction of the arrow w in FIG. 1 by the operation of the electric water pump 14. The cooling water into which the magnetic heat storage material is mixed absorbs heat from the engine 12 in the heat absorbing part 13 and then passes through the electric water pump 14. As the electric water pump 14 generates mechanical power by the force of electricity and magnetism, the magnetic heat storage material in the cooling water is magnetized and the temperature thereof is raised instantaneously.

After passing through the electric water pump 14, the cooling water flows into the heater core 15. The permanent magnets 17 are arranged on the cooling water inlet side of the heater core 15 at the side from which the cooling water flows into the heater core 15 and a magnetic field is applied to the magnetic heat storage material in the cooling water. As the magnetic heat storage material is magnetized by the magnetic field and put into a high-temperature state, the temperature of the cooling water around the magnetic heat storage material is also raised.

In this state, the air supplied from the blower 16 flows into the corrugated fins 15b making up the core part 15c of the heater core 15, as shown by the arrow c in FIG. 2, and effects heat exchange with the cooling water in a high-temperature state flowing in the tubes 15a as shown by the dotted line arrow in FIG. 2. In other words, the air supplied from the blower 16 becomes hot by taking heat from (by being given heat by) the cooling water in the heater core 15.

The cooling water and the magnetic heat storage material from which heat has been taken by the air supplied from the blower 16 pass through the magnetic field shielding plate 18 and flows through the part 15f of the heater core 15 to which no magnetic fields is applied by the permanent magnets 17. At this time, as the magnetic heat storage material is demagnetized and put into a low-temperature state, the temperature of the cooling water around the magnetic heat storage material is also reduced. The cooling water, the temperature of which has been reduced, reaches the heat absorbing part 13 again and absorbs heat from the engine 12.

In the present embodiment, the quantity of heat to be exchanged at the heat absorbing part 13 and at the heater core 15 is adjusted by the adjustment and control of the flow rate of the cooling water that circulates through the cooling water channel 11 by means of the electric water pump 14 and the flow rate of the magnetic heat storage material in the cooling water.

Next, the functions and effects of the first embodiment are listed below.

(1) The container for accommodating the magnetic heat storage material and the drive means for moving the container needed in the heat exchanger described in Patent document 1 can be dispensed with because the magnetic heat storage material is mixed into the cooling water that flows through the cooling water channel 11, the cooling water and the magnetic heat storage material are circulated by the electric water pump 14, and the magnetic heat storage material is magnetized and demagnetized by making the magnetic heat storage material pass through the magnetic field produced by the magnetic field generation means 17.

(2) The permanent magnets 17 are arranged at the heater core 15 in order to apply a magnetic field to the fluid and heat is taken from the magnetic heat storage material, that has been magnetized and put into a high-temperature state, by the air supplied from the blower 16 in the heater core 15. Then, after passing through the heater core 15, the magnetic heat storage material is demagnetized and put into a low-temperature state and, therefore, the cooling water around the magnetic heat storage material is also put into a low-temperature state and, thus, the cooling water is enabled to absorb heat from the engine 12 at the heat absorbing part 13.

As described above, heat absorption at the heat exchanging part 13 and heat radiation from the heater core 15 can be performed successively by means of the cooling water and the magnetic heat storage material and, therefore, it is not necessary to move the two magnetic heat storage containers alternately between the place for magnetization and the place for demagnetization, and for the channel switching means to switch and control the channels in accordance with the movement, which is necessary in the heat exchanger described in Patent document 1. As a result, the channel switching means, which is indispensable to the heat exchanger described in Patent document 1, can be dispensed with.

(3) As the powdery magnetic heat storage material is mixed into the cooling water, the contact area between the magnetic heat storage material and the cooling water is increased and the effectiveness of heat exchange can be improved compared to the case where heat exchange is effected between the magnetic heat storage material in the container and the cooling water as in the heat exchanger described in Patent document 1.

(4) As a magnetic field can be applied to a part of the fluid channel in the heater core 15 by the permanent magnets 17, it is possible to raise the temperature of the cooling water at the part by making the magnetic heat storage material at the part in the cooling water generate heat.

For example, it is possible to raise the temperature of the fluid at a part, at which the temperature of the fluid is unlikely to rise because of the shape of the fluid channel, by applying a magnetic field to the part to put the magnetic heat storage material in the fluid into a magnetized high-temperature state. Due to this, it is possible to make the temperature of the fluid in the fluid channel even.

Moreover, when, for example, there are variations in the temperature of the air flowing into the core part 15c in the heater core 15 from the blower 16, it is possible to reduce the variations in the temperature of the air after the air passes through the heater core 15 by arranging the permanent magnet 17, at a part at which the temperature of the air flowing into the part is low, to raise the temperature of the cooling water.

(5) As the permanent magnets 17 are arranged integrally with the heater core 15, the magnetic field of the permanent magnets 17 can be efficiently applied to the magnetic heat storage material in the fluid and, therefore, the magnetic heat storage material can be effectively magnetized and put into a high-temperature state.

(6) As it is possible to form, in the heater core 15, a part at which the magnetic heat storage material is magnetized and put into a high-temperature state and another part at which the magnetic heat storage material is demagnetized and put into a low-temperature state so that both parts coexist in the same heater core 15, the exchanger can be made more compact and the manufacturing cost thereof can be reduced compared to the case where these parts are provided in separate containers.

(7) In the heater core 15, as the part 15e having the fluid channel to which a magnetic field is applied is formed of a material that does not block the magnetic field, such as aluminum and copper, it is possible to more certainly apply a magnetic field to the magnetic heat storage material in the fluid in the heater core 15 in order to put the magnetic heat storage material into a magnetized high-temperature state.

(8) As the magnetic field shielding plate 18 is provided, which prevents a magnetic field from being applied to a part of the fluid channel other than the part 15e having the fluid channel to which a magnetic field is applied from the permanent magnets 17 in the heater core 15, it is possible to magnetize the magnetic heat storage material only at a part of the fluid channel that needs to be magnetized and to more certainly adjust the temperature of the fluid in the fluid channel.

(9) The heater core 15 having the permanent magnets 17 in order to put the magnetic heat storage material into a magnetized high-temperature state and in which the cooling water transfers heat to an object to be heated is arranged at the downstream side of the electric water pump 14. Therefore, even if the magnetic heat storage material in the cooling water (fluid) is magnetized and put into a high-temperature state by the magnetism of the electric water pump 14 and the fluid is heated, the influence of the heated fluid with respect to the heat exchanging performance of the heat exchanger can be obviated because the fluid is just heated further by the magnetic heat storage material, which is magnetized and put into a high-temperature state by the permanent magnets 17 in the heater core 15 at the downstream side.

(10) As the flow rate of the fluid is controlled by means of the electric water pump 14, the flow rate of the magnetic heat storage material, which circulates through the cooling water channel 11 together with the cooling water, passing through the magnetic field of the permanent magnets 17 on the heater core 15 can also be controlled. Therefore, by adjusting the flow rate of the cooling water by means of the electric water pump 14, it is possible to adjust the flow rate of the magnetic heat storage material that can be magnetized and put into a high-temperature state and demagnetized and put into a low-temperature state, and thus the level of the heat exchanging ability of the heater core 15 can be changed.

(Second Embodiment)

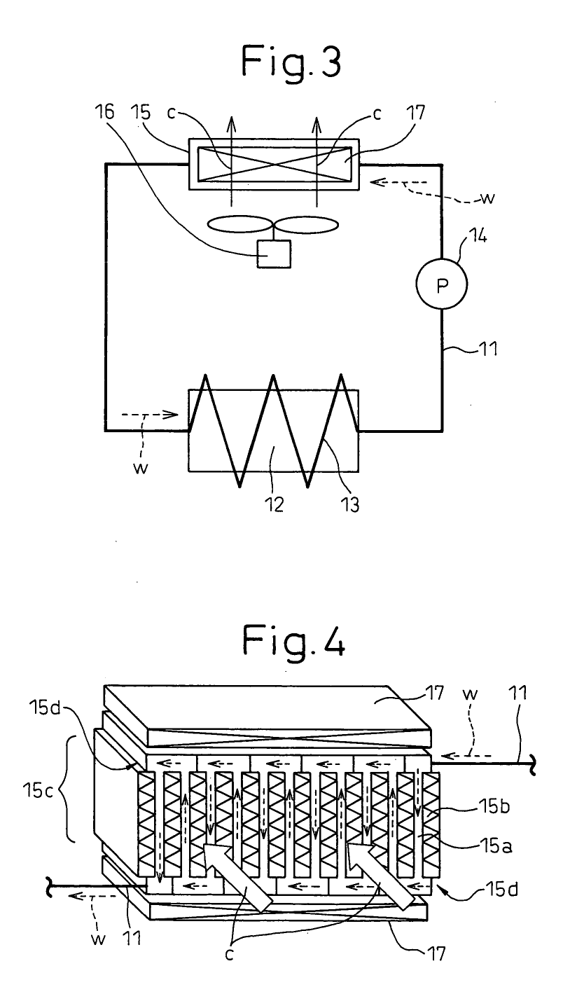

The arrangement of each component in a second embodiment is substantially the same as that in the first embodiment, but permanent magnets 17, which apply a magnetic field to a part of the fluid channel in a heater core 15 in the first embodiment, are arranged so as to apply the magnetic field to the whole fluid channel in a heater core 15 in the present embodiment, as shown in FIG. 3 and FIG. 4. As a matter of course, therefore the magnetic field shielding plate 18 is removed.

In the present embodiment also, the cooling water circulates in the direction of the arrow w in FIG. 3 by means of an electric water pump 14 as in the first embodiment. In the heater core 15, the temperature of the cooling water, which has been raised by the magnetic heat storage material magnetized and put into a high-temperature state by the permanent magnets 17, is reduced because the heat of the cooling water is taken by the air supplied from the blower 16 and flowing into corrugated fins 15b making up a core part 15c. Moreover, the temperature of the cooling water that has flowed out from the heater core 15 is further reduced because the magnetic heat storage material in the cooling water is demagnetized and put into a low-temperature state. The cooling water the temperature of which has been reduced reaches a heat absorbing part 13 and absorbs heat from an engine 12.

In the second embodiment also, the effects (1) to (3), (9), and (10) described in the first embodiment can be exhibited.

(Third Embodiment)

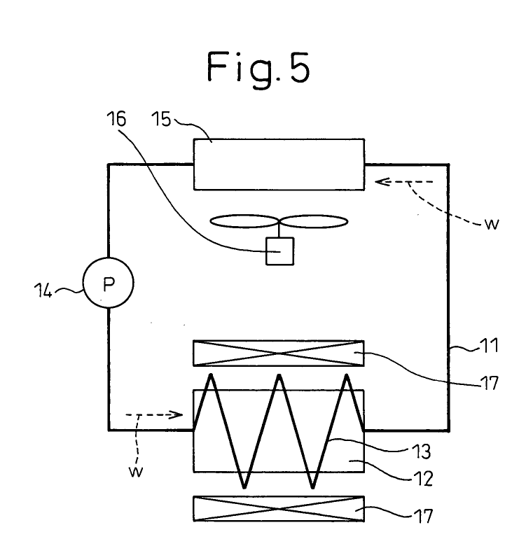

In a third embodiment, permanent magnets 17, which are arranged on the heater core 15 in the first and second embodiments, are arranged on a heat exchanging part 13 at which heat exchange is effected with an engine 12, as shown in FIG. 5. In the third embodiment, the heat exchanging part 13, an electric water pump 14, and a heater core 15 are arranged in a cooling water channel 11, as in the first and second embodiments. Then, the permanent magnets 17 that apply a magnetic field to the magnetic heat storage material in the fluid are arranged at the heat exchanging part 13.

According to the third embodiment, when it is necessary to warm up the engine 12 in a low-temperature state, if the cooling water into which the magnetic heat storage material is mixed is circulated, the magnetic heat storage material is magnetized and put into a high-temperature state by the magnetic field of the permanent magnets 17 at the heat exchanging part 13 and the cooling water therearound is heated. Then, the heat of the cooling water is transferred to the engine 12, enabling the warm-up of the engine 12.

In FIG. 5, the permanent magnets 17 are arranged so as to apply a magnetic field to the whole heat exchanging part 13, but it may also be possible to promote a rise in temperature of the cooling water at a part of the heat exchanging part 13, at which it is difficult to raise the temperature of the cooling water, by applying a magnetic field to the part.

(Fourth Embodiment)

In a fourth embodiment, three circulation channels through which the cooling water circulates are provided, in other words, a first circulation channel 20, a second circulation channel 21, and an intermediate circulation channel 24 are provided and these three circulation channels 20, 21, and 24 are provided with electric water pumps 14a, 14b, and 14c that circulate the cooling water, respectively.

In the circulation channels 20, 21, and 24, the electric water pumps 14a, 14b, and 14c are arranged at the upstream side of heat exchanging means 15, 23b and 23a, respectively, in which the cooling water heats an object with which heat exchange is effected, and at the same time, at the downstream side of heat exchanging means 23a, 13, and 23b, respectively, in which the fluid takes heat from an object with which heat exchange is effected.

Further, in the first circulation channel 20, the heating type heat exchanging means 15, in which the cooling water heats an object to be heated, is arranged and in the second circulation channel 21, the heat-absorbing type heat exchanging means 13, in which the cooling water takes heat from an object to be cooled, is arranged.

As in the first to third embodiments, the magnetic heat storage material that is, when magnetized, put into a high-temperature state because of a rise in temperature and which is, when demagnetized, put into a low-temperature state because of a fall in temperature due to a magneto-caloric effect, is mixed into the cooling water. In the present embodiment, however, as the temperature of the cooling water becomes higher in the order of the second circulation channel 21 to the intermediate circulation channel 24 to the first circulation channel 20, the magnetic heat storage materials are mixed into the respective channels 21, 24, and 20 so that the Curie temperature of the respective magnetic heat storage materials in the cooling waters in the respective channels 21, 24, and 20 becomes higher in that order in accordance with the temperature rise of the cooling waters in the channels 21, 24 and 20.

At the heating type heat exchanging means 15, a permanent magnet 17a that applies a magnetic field to the magnetic heat storage material in the cooling water is arranged. At parts in opposition to the heating type heat exchanging means 15 and the heat-absorbing type heat exchanging means 13, the blowers 16 that supply air toward the heating type heat exchanging means 15 and the heat-absorbing type heat exchanging means 13 are arranged, respectively.

Moreover, the heat exchanger according to the fourth embodiment comprises a first intermediate heat exchanger 23a that effects heat exchange between the cooling water in the intermediate circulation channel 24 and the cooling water in the first circulation channel 20, and a second intermediate heat exchanger 23b that effects heat exchange between the cooling water in the second circulation channel 21 and the cooling water in the intermediate circulation channel 24.

The respective first intermediate heat exchanger 23a and the second intermediate heat exchanger 23b comprise: respective permanent magnets 17c and 17b that apply a magnetic field to the cooling water in the respective circulation channels 24 and 21 from which heat is taken and magnetic field shielding plates 18a and 18b that make the permanent magnets 17c and 17b apply a magnetic field only to the cooling water in the circulation channels 24 and 21 from which heat is taken.

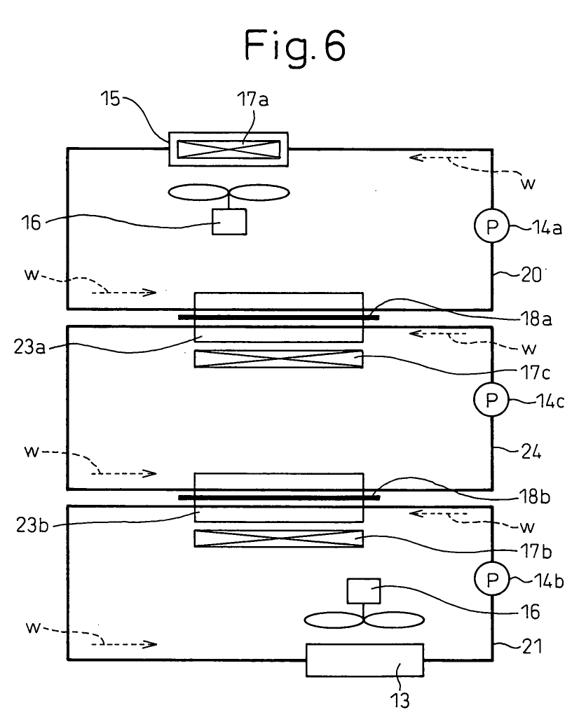

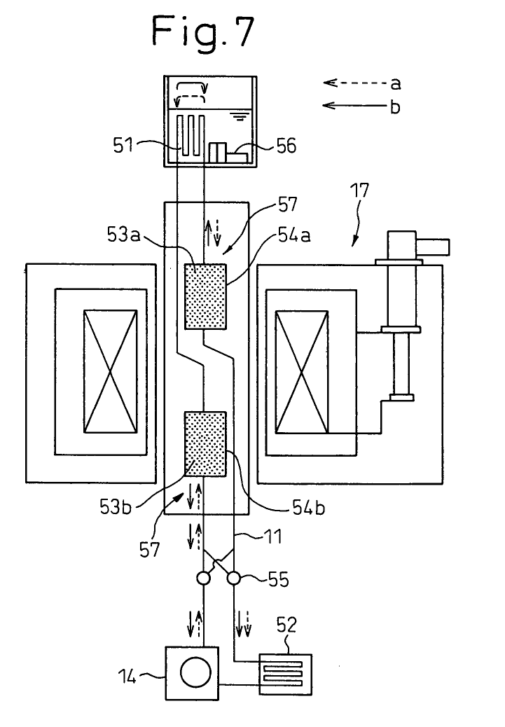

Next, the operations in the configuration in the present embodiment are explained below. The cooling water in each of the circulation channels 20, 21, and 24 circulates in the direction of the arrow w in FIG. 6 by the operations of the electric water pumps 14a, 14b, and 14c. The cooling water in the second circulation channel 21 absorbs heat from the air supplied from the blower 16 in the heat-absorbing type heat exchanging means 13. Then the cooling water in the second circulation channel 21 radiates the heat produced by the magnetization of the magnet heat storage material and the heat of the cooling water to the cooling water in the intermediate circulation channel 24 in the second intermediate heat exchanger 23b having the permanent magnet 17b. At this time, as a magnetic field is applied only to the cooling water in the second circulation channel 21 by the effects of the permanent magnet 17b and the magnetic field shielding plate 18b of the second intermediate heat exchanger 23b, the magnetic heat storage material is magnetized and heats the cooling water in the second circulation channel 21 and the heat is transferred to the cooling water in the intermediate circulation channel 24.

Moreover, the cooling water in the intermediate circulation channel 24 that is heated in the second intermediate heat exchanger 23b radiates the heat, produced by the magnetization of the magnetic heat storage material and the heat of the cooling water, to the cooling water in the first circulation channel 20 at the first intermediate heat exchanger 23a having the permanent magnet 17c. At this time, as a magnetic field is applied only to the cooling water in the intermediate circulation channel 24 by the effects of the permanent magnet 17c and the magnetic field shielding plate 18a of the first intermediate heat exchanger 23a, the magnetic heat storage material is magnetized and heats the cooling water in the intermediate circulation channel 24 and the heat is transferred to the cooling water in the first circulation channel 20.

Then, the cooling water in the first circulation channel 20 that is heated in the first intermediate heat exchanger 23a is heated by the magnetization of the magnetic heat storage material in the heating type heat exchanging means 15 having the permanent magnet 17a and the cooling water in a high-temperature state heats the air, which is an object to be heated, supplied from the blower 17.

In the present embodiment also, as in the first embodiment, the quantity of heat to be exchanged in the heat exchanging means 13, 15, 23a, and 23b is adjusted by adjusting and controlling the flow rate of the cooling water that circulates through the circulation channels 20, 21, and 24 and the flow rate of the magnetic heat storage material in the cooling water by means of the electric water pumps 14a, 14b, and 14c.

Next, the functions and effects of the fourth embodiment are described below. The heat of the magnetic heat storage material magnetized by the permanent magnets 17c and 17b arranged in the first and second intermediate heat exchangers 23a and 23b is transferred from the second circulation channels 21 to the intermediate circulation channel 24 and then to the first circulation channel 20 in this order. Due to this, the temperature of the cooling water in the heating type heat exchanging means 15 in the first circulation channel 20 becomes higher than that in the case where there is only one circulation channel and, therefore, it is possible to give much more heat to an object to be heated.

Moreover, at the first intermediate heat exchanger 23a, the permanent magnet 17c and the magnetic field shielding plate 18a are arranged so that a magnetic field is applied only to the cooling water in the intermediate circulation channel 24, and at the second intermediate heat exchanger 23b, the permanent magnet 17b and the magnetic field shielding plate 18b are arranged so that a magnetic field is applied only to the cooling water in the second circulation channel 21. Due to this, it is possible to effect heat exchange in a single heat exchanger in such a manner that cooling water in a certain circulation channel is heated by the magnetization of a magnetic heat storage material and cooling water in a low-temperature state in another circulation channel absorbs heat from the certain heated cooling water.

As the respective magnetic heat storage materials having the respective Curie temperatures suitable to the respective temperature ranges of the cooling waters are mixed into the cooling waters in the respective circulation channels 20, 21, and 24, it is possible to effect heat exchange more efficiently by means of the magnetic heat storage materials.

Moreover, the respective electric water pumps 14a, 14b, and 14c are arranged at the upstream part of the respective heat exchanging means 15, 23b, and 23a in which the cooling water (fluid) gives heat to an object with which heat exchange is effected, in the respective circulation channels 20, 21, and 24 and, at the same time, at the downstream part of the respective heat exchanging means 23a, 13 and 23b in which the fluid absorbs heat from an object with which heat exchange is effected.

Due to this, the influence on the heat exchanging performance of the heat exchanger can be obviated for the same reason as that described in the effect (9) in the first embodiment.

As the flow rate of the fluid is controlled by means of the electric water pumps 14a, 14b, and 14c, it is possible to adjust the flow rate of the magnetic heat storage material that circulates through the circulation channels 20, 21, and 24 and is put into a magnetized high-temperature state and a demagnetized low-temperature state by adjusting and controlling the flow rate of the cooling water by means of the electric water pumps 14a, 14b, and 14c for the same reason as that described in the effect (10) in the first embodiment and, thus, the level of the heat exchanging ability of the heat exchanging means 13, 15, 23a, and 23b can be changed.

In the fourth embodiment also, the effects (1) to (3) described in the first embodiment can be exhibited.

(Other Embodiments)

In the first to third embodiments described above, examples in which a gadolinium base material is used as a magnetic heat storage material are explained, but any material may be used provided that the material exhibits a magneto-caloric effect, in other words, the material is, when magnetized, put into a high-temperature state and is, when demagnetized, put into a low-temperature state.

In the first to third embodiments described above, examples in which heat is absorbed from the vehicle engine 12 in the heat absorbing part 13 are explained, but an object from which heat is absorbed may be a heat generating body, such as an electronic device, an electricity generating device, a battery, a fuel cell, or the like, and is not limited to a vehicle engine.

In the first to fourth embodiments, examples are described in which the permanent magnet 17 is used as a magnetic field generation means, but it is apparent that a magnetic field may be generated by an electromagnet.

In the fourth embodiment, an example in which the three circulation channels 20, 21, and 24 are provided is explained, but there may be a case where only the first and second circulation channels 20 and 21 are provided as circulation channels. Moreover, an example in which only the intermediate circulation channel 24 is provided is explained, but there may be a case where a plurality of intermediate circulation channels are provided. It is apparent that the total number of intermediate heat exchanging means is increased or decreased according to the number of intermediate circulation channels.

While the invention has been described by reference to specific embodiments chosen for the purposes of illustration, it should be apparent that numerous modifications could be made thereto, by those skilled in the art, without departing from the basic concept and scope of the invention.

1. A heat exchanger, comprising a circulation channel through which a fluid circulates,
wherein the circulation channel comprises:
a heating type heat exchanging means in which the fluid heats an object to be heated;
a heat-absorbing type heat exchanging means in which the fluid absorbs heat from an object to be cooled; and
a circulating means for circulating the fluid;
wherein a magnetic heat storage material that is, when magnetized, put into a high-temperature state because of a rise in temperature and which is, when demagnetized, put into a low-temperature state because of a fall in temperature due to a magneto-caloric effect thereof, is mixed into the fluid; and
wherein a magnetic field generation means for applying a magnetic field to the fluid is arranged on the heating type heat exchanging means.

2. A heat exchanger as set forth in claim 1, wherein the magnetic field generation means is arranged integrally with the heating type heat exchanging means so as to apply a magnetic field to at least a part of a fluid channel in the heating type heat exchanging means.

3. A heat exchanger as set forth in claim 2, wherein a part in the heating type heat exchanging means which includes a fluid channel to which the magnetic field is applied is formed of a non-magnetic material.

4. A heat exchanger as set forth in claim 3, wherein the heating type heat exchanging means comprises a magnetic field shielding plate for blocking the magnetic field from the magnetic field generation means.

5. A heat exchanger, comprising:
a plurality of circulation channels through which a fluid circulates;
circulating means arranged in the plurality of circulation channels, respectively, and circulating the fluid;
intermediate heat exchanging means arranged in the plurality of circulation channels, respectively, and effecting heat exchange with cooling water in other circulation channels;
a heating type heat exchanging means arranged in a first circulation channel, which is one of the plurality of circulation means, and in which the fluid heats an object to be heated; and
a heat-absorbing type heat exchanging means arranged in a second circulation channel, which is one of the plurality of circulation channels except for the first circulation channel, and in which the fluid absorbs heat from an object to be cooled;
wherein a magnetic heat storage material that is, when magnetized, put into a high-temperature state because of a rise in temperature and which is, when demagnetized, put into a low-temperature state because of a fall in temperature due to a magneto-caloric effect, is mixed into the fluid;
wherein a magnetic field generation means for applying a magnetic field to the fluid in the first circulation channel is arranged on the heating type heat exchanging means; and
wherein the respective intermediate heat exchanging means comprise magnetic field generation means for applying a magnetic field to the fluid in the circulation channels for heating and respective magnetic field shielding plates for making the magnetic field generation means of the intermediate heat exchanging means apply a magnetic field only to the fluid in the circulation channels for heating.

6. A heat exchanger as set forth in claim 5, wherein the magnetic heat storage materials mixed into the respective fluids in the plurality of circulation channels have different Curie temperatures.

7. A heat exchanger as set forth in claim 1, wherein the one or more circulating means is arranged between the upstream side of the heating type heat exchanging means and the downstream side of the heat-absorbing type heat exchanging means, in the one or more circulation channels.

8. A heat exchanger as set forth in claim 1, wherein the quantity of heat to be exchanged in the heat exchanging means is adjusted by controlling the flow rate of the fluid by means of the circulating means.

9. A heat exchanger as set forth in claim 5, wherein the one or more circulating means is arranged between the upstream side of the heating type heat exchanging means and the downstream side of the heat-absorbing type heat exchanging means, in the one or more circulation channels.

10. A heat exchanger as set forth in claim 5, wherein the quantity of heat to be exchanged in the heat exchanging means is adjusted by controlling the flow rate of the fluid by means of the circulating means.
